(19) United States
(12) Patent Application Publication
(10) Pub. No.: US 2021/0332254 A1
(43) Pub. Date: Oct. 28, 2021

(54) Aqueous Ink Jet Compostion And Method For Manufacturing Recorded Matter

(71) Applicant: Seiko Epson Corporation, Tokyo (JP)

(72) Inventors: Soichi YAMAZAKI, Shiojiri (JP); Manabu TANIGUCHI, Shiojiri (JP); Hiroaki KUMETA, Matsumoto (JP); Shunsuke UCHIZONO, Shiojiri (JP)

(21) Appl. No.: 17/237,111

(22) Filed: Apr. 22, 2021

(30) Foreign Application Priority Data
Apr. 23, 2020 (JP) 2020-076691

(51) Int. Cl. C09D 11/037; C09D 11/104; C09D 11/38; C08K 5/17; C08K 5/3415; B41J 11/00

(52) U.S. Cl. CPC C09D 11/037; C09D 11/104; B41J 11/002; C08K 5/17; C08K 5/3415; C09D 11/38

(57) ABSTRACT

An aqueous ink jet composition includes a pigment, polyester, 1-(hydroxyalkyl)-2-pyrrolidone, an organic amine, and water, wherein the pigment, the polyester, and the 1-(hydroxyalkyl)-2-pyrrolidone have a relationship of expression (1): C≤A≤B, where A is the content (mass %) of the pigment with respect to the total mass, B is the content (mass %) of the polyester with respect to the total mass, and C is the content (mass %) of the 1-(hydroxyalkyl)-2-pyrrolidone with respect to the total mass.

The present application is based on, and claims priority from JP Application Serial Number 2020-076691, filed Apr. 23, 2020, the disclosure of which is hereby incorporated by reference herein in its entirety.

### BACKGROUND

### 1. Technical Field

The present disclosure relates to an aqueous ink jet composition and a method for manufacturing a recorded matter.

### 2. Related Art

An ink jet method is tried to be applied to not only recording images on recording media but also printing on fabrics, and a variety of ink compositions for ink jet printing have been studied. An aqueous ink jet composition for printing contains a color material for obtaining an image having desired color, and as the color material, a dye or a pigment is used. In addition, an aqueous ink jet composition for printing is also required to have the same or better performance as a normal aqueous ink jet composition.

For example, as an aqueous ink jet composition, a composition containing a pigment has also been studied. JP-A-2004-035718 describes an ink containing a self-dispersible pigment and a water-dispersible resin as an attempt of overcoming the problems such as bleeding, color mixing, optical density, and set-off on plain paper and providing a pigment ink having excellent dischargeability.

JP-A-2004-035718 also describes that polyester is added for securing fixability. However, in the addition amount of polyester described in JP-A-2004-035718, the fixability is insufficient, in particular, when printing is performed on a non-absorptive recording medium. On the other hand, an increase in the addition amount of a water-dispersible resin for enhancing the fixability causes a concern that reliability such as clogging recovery will decrease. Accordingly, an aqueous ink jet composition containing a pigment, the composition being unlikely to cause clogging of a nozzle of an ink jet head or being likely to easily recover clogging without impairing the fixability of the pigment to a recording medium, is required.

### SUMMARY

An aspect of the aqueous ink jet composition according to the present disclosure includes a pigment, polyester, 1-(hydroxyalkyl)-2-pyrrolidone, an organic amine, and water, wherein the pigment, the polyester, and the 1-(hydroxyalkyl)-2-pyrrolidone have a relationship of expression (1): C≤A≤B, where A is the content (mass %) of the pigment with respect to the total mass of the aqueous ink jet composition, B is the content (mass %) of the polyester with respect to the total mass of the aqueous ink jet composition, and C is the content (mass %) of the 1-(hydroxyalkyl)-2-pyrrolidone with respect to the total mass of the aqueous ink jet composition.

An aspect of the method for manufacturing a recorded matter according to the present disclosure includes an imparting step of discharging the aqueous ink jet composition described above by an ink jet method to impart the composition to a recording medium and a heating step of heating the recording medium imparted with the aqueous ink jet composition to a temperature not lower than the glass transition temperature of the polyester.

### DESCRIPTION OF EXEMPLARY EMBODIMENTS

Embodiments of the present disclosure will now be described. The embodiments described below describe examples of the present disclosure. The present disclosure is not limited to the following embodiments and includes various modifications that are implemented within a range not changing the gist of the present disclosure. It should be noted that not all of the configurations described below are essential configurations of the present disclosure.

### 1. Aqueous Ink Jet Composition

An aqueous ink jet composition of the present embodiment includes a pigment, polyester, 1-(hydroxyalkyl)-2-pyrrolidone, an organic amine, and water. The contents of the pigment, the polyester, and the 1-(hydroxyalkyl)-2-pyrrolidone are set to have a specific relationship.

### 1.1. Pigment

The aqueous ink jet composition includes a pigment. As the pigment, either a non-white pigment or a white pigment can be used. Examples of the non-white pigment include carbon black and non-white inorganic and organic pigments.

As the non-white inorganic pigment, for example, carbon blacks (C.I. Pigment Black 7), such as furnace black, lamp black, acetylene black, or channel black, or iron oxide can be used.

As the non-white organic pigment, for example, quinacridone pigments, quinacridonequinone pigments, dioxazine pigments, phthalocyanine pigments, anthrapyrimidine pigments, anthanthrone pigments, indanthrone pigments, flavanthrone pigments, perylene pigments, diketopyrrolopyrrole pigments, perinone pigments, quinophthalone pigments, anthraquinone pigments, thioindigo pigments, benzimidazolone pigments, isoindolinone pigments, azomethine pigments, and azo pigments are exemplified.

Examples of the non-white organic pigment used in the aqueous ink jet composition include the followings.

Examples of cyan pigments include C.I. Pigment Blues 1, 2, 3, 15:3, 15:4, 15:34, 16, 22, and 60; and C.I. Vat Blues 4 and 60, and one or a mixture of two or more selected from the group consisting of C.I. Pigment Blues 15:3, 15:4, and 60 may be used.

Examples of magenta pigments include C.I. Pigment Reds 5, 7, 12, 48(Ca), 48(Mn), 57(Ca), 57:1, 112, 122, 123, 168, 184, and 202 and C.I. Pigment Violet 19, and one or a mixture of two or more selected from the group consisting of C.I. Pigment Reds 122, 202, and 209 and C.I. Pigment Violet 19 may be used.

Examples of yellow pigments include C.I. Pigment Yellows 1, 2, 3, 12, 13, 14C, 16, 17, 73, 74, 75, 83, 93, 95, 97, 98, 119, 110, 114, 128, 129, 138, 150, 151, 154, 155, 180, and 185, and one or a mixture of two or more selected from the group consisting of C.I. Pigment Yellows 74, 109, 110, 128, and 138 may be used.

Pigments of color other than the above can be used, and examples thereof include an orange pigment and a green pigment.

The aqueous ink jet composition may contain a white pigment as a color material. Examples of the white pigment include metal compounds, such as a metal oxide, barium sulfate, and calcium carbonate. Among these examples, examples of the metal oxide include titanium dioxide, zinc oxide, silica, alumina, and magnesium oxide. In addition, as the white pigment, a particle having a hollow structure may be used, and as the particle having a hollow structure, a known particle can be used.

Among the above-mentioned examples, the white pigment may be titanium dioxide from the viewpoint of improving the whiteness and abrasion resistance of images. In addition, a single white pigment may be used, or a combination of two or more white pigments may be used.

The pigments mentioned above are merely examples, and the present disclosure is not limited by them. These pigments may be used singly or as a mixture of two or more.

The content of the pigment can be appropriately adjusted according to the application and may be 0.10 mass % or more and 20.0 mass % or less, 0.20 mass % or more and 15.0 mass % or less, or 1.0 mass % or more and 10.0 mass % or less.

The volume average particle diameter of the pigment particles may be 10.0 nm or more and 200.0 nm or less, 30.0 nm or more and 200.0 nm or less, 50.0 nm or more and 150.0 nm or less, or 70.0 nm or more and 120.0 nm or less.

The volume average particle diameter of the pigment can be measured with a particle size distribution measuring apparatus using a laser diffraction scattering method as the measurement principle. Examples of the particle size distribution measuring apparatus include a particle size distribution analyzer (e.g., “Microtrack UPA”, manufactured by Nikkiso Co., Ltd.) using a dynamic light scattering method as the measurement principle.

The above-described non-white pigment and white pigment may be dispersed using a dispersant for capable of being stably dispersed in water. The dispersant may be any of a surfactant, a resin dispersant, or the like. In addition, the non-white pigment and the white pigment may be used as a self-dispersible pigment by modifying the surface of the pigment particle by oxidation or sulfonation with, for example, ozone, hypochlorous acid, or fuming sulfuric acid.

Examples of the resin dispersant include water-soluble resins, for example, (meth)acrylic resins and salts thereof, such as poly(meth)acrylic acid, a (meth)acrylic acid-acrylnitrile copolymer, a (meth)acrylic acid-(meth)acrylic ester copolymer, a vinyl acetate-(meth)acrylic ester copolymer, a vinyl acetate-(meth)acrylic acid copolymer, and a vinylnaphthalene-(meth)acrylic acid copolymer; styrene resins and salts thereof, such as a styrene-(meth)acrylic acid copolymer, a styrene-(meth)acrylic acid-(meth)acrylic ester copolymer, a styrene-a-methylstyrene-(meth)acrylic acid copolymer, a styrene-a-methylstyrene-(meth)acrylic acid-(meth)acrylic ester copolymer, a styrene-maleic acid copolymer, and a styrene-maleic anhydride copolymer; urethane resins and salts thereof that are polymer compounds (resins) including a urethane bond formed by a reaction of an isocyanate group and a hydroxyl group, being linear and/or branched, and having a crosslinked structure or not; polyvinyl alcohols; vinylnaphthalene-maleic acid copolymers and salts thereof; vinyl acetate-maleic ester copolymers and salts thereof; and vinyl acetate-crotonic acid copolymers and salts thereof.

Among them, the dispersant may be a copolymer of a monomer including a hydrophobic functional group and a monomer including a hydrophilic functional monomer or a polymer of a monomer including both a hydrophobic functional group and a hydrophilic functional group. As the form of the copolymer, any form of a random copolymer, a block copolymer, an alternating copolymer, and a graft copolymer can be used.

Examples of commercially available styrene resin dispersant include X-200, X-1, X-205, X-220, and X-228 (manufactured by Seiko PMC Corporation), NOPCOSPERSE (registered trademark) series 6100 and 6110 (manufactured by SAN NOPCO Ltd.), Joncryl series 67, 586, 611, 678, 680, 682, and 819 (manufactured by BASF SE), DISPERBYK-190 (manufactured by BYK Chemie Japan K.K.), and N-EA137, N-EA157, N-EA167, N-EA177, N-EA197D, N-EA207D, and E-EN10 (manufactured by DKS Co., Ltd.).

Examples of commercially available acrylic resin dispersant include BYK-187, BYK-190, BYK-191, BYK-194N, and BYK-199 (manufactured by BYK Chemie GmbH) and Aron series A-210, A6114, AS-1100, AS-1800, A-30SL, A-7250, and CL-2 (manufactured by Toagosei Co., Ltd.).

Furthermore, examples of commercially available urethane resin dispersant include BYK-182, BYK-183, BYK-184, and BYK-185 (manufactured by BYK Chemie GmbH), TEGO Disperse 710 (manufactured by Evonik Tego Chemie GmbH), and Borchi (registered trademark) Gen 1350 (manufactured by OMG Borchers GmbH).

The resin dispersants may be used singly or in combination of two or more. The total content of the resin dispersants is 0.1 parts by mass or more and 30 parts by mass or less with respect to 50 parts by mass of the pigment as the target and may be 0.5 parts by mass or more and 25 parts by mass or less, 1 part by mass or more and 20 parts by mass or less, or 1.5 parts by mass or more and 15 parts by mass or less.

When the content of the resin dispersants is 0.1 parts by mass or more with respect to 50 parts by mass of the pigment as the target, the dispersion stability of the pigment can be further enhanced. In addition, when the content of the resin dispersants is 30 parts by mass or less with respect to 50 parts by mass of the pigment, the viscosity of the resulting dispersion can be suppressed low.

Among the resin dispersants mentioned above, in particular, the dispersant may be at least one selected from the group consisting of acrylic resins, styrene resins, and urethane resins. In addition, in such a case, the weight average molecular weight of the dispersant may be 500 or more. When the dispersant is a resin dispersant, the odor is low, and the dispersion stability of the pigment can be further improved.

In the aqueous ink jet composition of the present embodiment, when the pigment is dispersed by a resin dispersant, the ratio of the pigment to the resin dispersant may be 10:1 to 1:10 and may be 4:1 to 1:3. In addition, regarding the volume average particle diameter of the pigment at the time of dispersion, when measured by a dynamic light scattering method, the maximum particle diameter is less than 500 nm, and the average particle diameter is 300 nm or less. The average particle diameter may be 200 nm or less.

Incidentally, in the present specification, the notation “(meth)acrylic” means at least one of acrylic and methacrylic, and the notation “(meth)acrylate” means at least one of acrylate and methacrylate.

### 1.2. Polyester

The aqueous ink jet composition of the present embodiment includes polyester. The polyester may be any polymer material that has an ester bond in the main chain and, for example, may be unmodified polyester or modified polyester.

Examples of commercially available polyester that can be used in the aqueous ink jet composition include Polyester manufactured by The Nippon Synthetic Chemical Industry Co., Ltd., Plas Coat (registered trademark) manufactured by Goo Chemical Co., Ltd., Aron Melt (registered trademark) manufactured by Toagosei Co., Ltd., ELITEL (registered trademark) manufactured by UNITIKA Ltd., PESRESIN (registered trademark) manufactured by Takamatsu Oil & Fat Co., Ltd., SUPERFLEX (registered trademark) manufactured by DKS Co., Ltd., VYLONAL (registered trademark) manufactured by TOYOBO Co., Ltd., and Nipolon (registered trademark) which is polyester polyol manufactured by TOSOH Corporation. When a product that is put on the market as a polyester water dispersion is used, the content of the polyester is adjusted such that the content of the polyester as a solid content has a relationship described below.

The lower limit of acid value of the polyester can be 1.0 KOH mg/g and may be 1.5 KOH mg/g or 2.0 KOH mg/g. In addition, the upper limit of acid value of the polyester constituting the aqueous ink jet composition can be 15 KOH mg/g and may be 10 KOH mg/g or 5.0 KOH mg/g.

The lower limit of hydroxyl value of the polyester can be 1.0 KOH mg/g and may be 2.0 KOH mg/g or 3.0 KOH mg/g. In addition, the upper limit of hydroxyl value of the polyester constituting the aqueous ink jet composition can be 20.0 KOH mg/g and may be 15.0 KOH mg/g or 10.0 KOH mg/g.

The lower limit of number average molecular weight of the polyester can be 2000 and may be 6000 or 10000. In addition, the upper limit of number average molecular weight of the polyester constituting the aqueous ink jet composition can be 25000 and may be 20000 or 18000.

The glass transition temperature of the polyester can be −5° C. or higher and may be 10° C. or higher. The glass transition temperature can be 90° C. or less and may be 70° C. or less. When the glass transition temperature of the polyester is within such a range, the pigment can easily obtain fixability, when adhering to a recording medium and heated, and also is easily formed into a film together with the polyester at a temperature not damaging the recording medium.

The polyester may be in any form in the aqueous ink jet composition. For example, the polyester may be contained in a dissolution state in the aqueous ink jet composition or may be contained in a dispersion state such as a colloid state or an emulsion state. Alternatively, the polyester may be contained in a gelled state. In addition, the polyester may coat at least a part of the surface of the pigment in the aqueous ink jet composition. Furthermore, these states may be mixed.

The polyester may be contained as particles dispersed in the aqueous ink jet composition. That is, the polyester may include polyester particles having a volume average particle diameter of 20.0 nm or more and 300.0 nm or less.

The lower limit of volume average particle diameter of the particulate polyester can be 20.0 nm and may be 40.0 nm or 60.0 nm. In addition, the upper limit of volume average particle diameter of the polyester can be 300.0 nm and may be 250.0 nm or 200.0 nm.

Consequently, the aqueous ink jet composition can be further easily prepared, and the dispersion stability of the polyester in the aqueous ink jet composition, the storage stability of the aqueous ink jet composition, and the discharge stability in an ink jet method and the clogging recovery of the aqueous ink jet composition can be made more excellent. The volume average particle diameter of the polyester particles can be measured as in the pigment.

The lower limit of content of the polyester in the aqueous ink jet composition can be 2.0 mass % and may be 5.0 mass % or 10.0 mass %. In addition, the upper limit of content of the polyester in the aqueous ink jet composition can be 40.0 mass % and may be 30.0 mass % or 20.0 mass %.

Consequently, the storage stability of the aqueous ink jet composition and the discharge stability and the clogging recovery of the aqueous ink jet composition by an ink jet method can be made more excellent. In addition, the fixability of the pigment to a recording medium can be made more excellent.

In addition, the content of the polyester may be higher than that of the above-described pigment, because the fixability of images can be made further higher. Furthermore, when the content of the polyester is 10.0 mass % or more and 20.0 mass % or less, the fixability of images can be more sufficiently increased, and the clogging recovery can be further improved.

### 1.3. 1-(Hydroxyalkyl)-2-pyrrolidone

1-(Hydroxyalkyl)-2-pyrrolidone is a compound in which a hydroxyalkyl group is bound to the 1-position of 2-pyrrolidone. Examples of the alkyl group thereof include a methyl group, an ethyl group, an n-propyl group, an iso-propyl group, an n-butyl group, a sec-butyl group, an iso-butyl group, a tert-butyl group, various pentyl groups, and various hexyl groups.

The hydroxyalkyl group is a group in which one or more hydrogen atoms of the alkyl group are substituted with hydroxyl groups. The number of the hydroxyl groups is arbitrary and may be one or two and may be one. Furthermore, the carbon of the alkyl group to which a hydroxyl group binds may be carbon that does not bind to the 2-pyrrolidone and may be carbon (carbon at the beta-position) binding to the carbon that binds to the 2-pyrrolidone.

Examples of the 1-(hydroxyalkyl)-2-pyrrolidone include 1-(2-hydroxyethyl)-2-pyrrolidone, 1-(2-hydroxypropyl)-2-pyrrolidone, 1-(3-hydroxypropyl)-2-pyrrolidone, 1-(2,3-dihydroxypropyl)-2-pyrrolidone, 1-(2-hydroxy-1-propyl)-2-pyrrolidone, 1-(2-hydroxy-n-butyl)-2-pyrrolidone, 1-(3,4-dihydroxy-n-butyl)-2-pyrrolidone, 1-(2,3-dihydroxy-n-butyl)-2-pyrrolidone, and 1-(2-hydroxy-t-butyl)-2-pyrrolidone.

Incidentally, for example, 1-(2-hydroxyethyl)-2-pyrrolidone is also called by another name, such as N-hydroxyethylpyrrolidone or 1-(2-hydroxyethyl)pyrrolidin-2-one.

The 1-(hydroxyalkyl)-2-pyrrolidone is contained in the aqueous ink jet composition of the present embodiment as an organic solvent. 1-(Hydroxyalkyl)-2-pyrrolidone includes a hydroxyl group and therefore has high hydrophilicity compared to other organic solvents. Accordingly, the aqueous ink jet composition containing the 1-(hydroxyalkyl)-2-pyrrolidone can enhance the dispersibility of the pigment therein and can prevent aggregation and solidification from occurring. When the aggregation and solidification of the pigment are unlikely to occur, the clogging recovery of the aqueous ink jet composition can be made excellent. In addition, this effect is particularly significant when the concentration of the pigment in the aqueous ink jet composition is high.

The content of the 1-(hydroxyalkyl)-2-pyrrolidone can be 0.5 mass % or more and 10.0 mass % or less based on the total mass of the aqueous ink jet composition and may be 1.0 mass % or more and 5.0 mass % or less or 1.0 mass % or more and 4.0 mass % or less. When the content of the 1-(hydroxyalkyl)-2-pyrrolidone is within this range, printing with further excellent clogging recovery can be performed.

### 1.4. Organic Amine

The aqueous ink jet composition of the present embodiment contains an organic amine. One of functions of the organic amine is adjustment of the pH of the composition and can function as a pH adjuster and/or a pH buffer.

Examples of the organic amine include triethanolamine, diethanolamine, monoethanolamine, tripropanolamine, triisopropanolamine, diisopropanolamine, tris(hydroxymethyl)aminomethane (THAM), and N,N-bis(2-hydroxyethyl)-2-aminoethanesulfonic acid (BES).

The use of the organic amine allows to appropriately adjust the pH of the aqueous ink jet composition to a predetermined pH of 6 or more and 10 or less. Among the above-mentioned organic amines, triethanolamine or tripropanolamine may be used. Consequently, the pH can be easily adjusted within a range of 6 or more and 10 or less when manufacturing the aqueous ink jet composition, and the range of the pH can be easily maintained even in long time storage.

The aqueous ink jet composition of the present embodiment may use a pH adjuster described below in addition to the organic amine.

The content of the organic amine in the aqueous ink jet composition is 0.01 mass % or more and 5.0 mass % or less based on the total mass of the composition and may be 0.05 mass % or more and 4.0 mass % or less, 0.1 mass % or more and 3.0 mass % or less, or 0.2 mass % or more and 2.0 mass % or less.

### 1.5. Water

The aqueous ink jet composition according to the present embodiment contains water. Examples of the water include water with low ionic impurities, for example, pure water, such as ion-exchanged water, ultrafiltered water, reverse osmosis water, and distilled water, and ultrapure water. In addition, the use of water sterilized by, for example, UV irradiation or addition of hydrogen peroxide can suppress the outbreak of bacteria and fungi when the aqueous ink jet composition is stored for a long time.

The content of water can be 30 mass % or more based on the total mass of the aqueous ink jet composition and may be 40 mass % or more, 45 mass % or more, or 50 mass % or more. The term water in the aqueous ink jet composition includes, for example, the water contained in raw materials and the water to be added. When the content of water is 30 mass % or more, the aqueous ink jet composition can have a relatively low viscosity. In addition, the upper limit of the content of water can be 90 mass % or less based on the total mass of the aqueous ink jet composition and may be 85 mass % or less or 80 mass % or less.

### 1.6. Other Component

### 1.6.1. Solvent

The aqueous ink jet composition may contain a solvent other than water.

Consequently, the viscosity of the aqueous ink jet composition can be suitably adjusted, or the moisture retaining property of the aqueous ink jet composition can be increased. As a result, droplet discharge by an ink jet method can be more stably performed.

Examples of the solvent other than water contained in the aqueous ink jet composition include alkyl polyol, glycol ether, and cyclic amide.

Examples of the alkyl polyol include 1,2-butanediol, 1,2-pentanediol, 1,2-hexanediol, 1,2-heptanediol, 1,3-propanediol, 1,3-butanediol, 1,4-butanediol, 1,5-pentanediol, 1,6-hexanediol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, diethylene glycol, propylene glycol, dipropylene glycol, triethylene glycol, and glycerol. These alkyl polyols may be used singly or in combination of two or more.

The glycol ether is, for example, monoalkyl ether or dialkyl ether of glycol selected from the group consisting of ethylene glycol, diethylene glycol, triethylene glycol, polyethylene glycol, propylene glycol, dipropylene glycol, tripropylene glycol, polypropylene glycol, and polyoxyethylene polyoxypropylene glycol. More specifically, examples of the glycol ether include methyl triglycol (triethylene glycol monomethyl ether), butyl triglycol (triethylene glycol monobutyl ether), butyl diglycol (diethylene glycol monobutyl ether), and dipropylene glycol monopropyl ether. A typical example is diethylene glycol monobutyl ether.

Examples of the cyclic amide include y-lactams, such as 2-pyrrolidone, 1-methyl-2-pyrrolidone (N-methyl-2-pyrrolidone), 1-ethyl-2-pyrrolidone (N-ethyl-2-pyrrolidone), 1-propyl-2-pyrrolidone, and 1-butyl-2-pyrrolidone, β-lactams, δ-lactams, and ε-lactams, such as ε-caprolactam. These cyclic amides may be used singly or in combination of two or more.

The aqueous ink jet composition may further contain an additional organic solvent. Examples of the additional organic solvent include lactones, such as γ-butyrolactone, and betaine compounds.

### 1.6.2. Other Materials

The aqueous ink jet composition of the present embodiment may contain a surfactant, a resin particle, a pH adjuster, a chelating agent, ureas, a preservative, a fungicide, a corrosion inhibitor, saccharides, and other additives, as materials in addition to the above-mentioned materials.

### Surfactant

The aqueous ink jet composition according to the present embodiment may include a surfactant. The surfactant can be used for reducing the surface tension of the aqueous ink jet composition to adjust or improve the wettability to a recording medium, for example, permeability to a fabric or the like. As the surfactant, any of nonionic surfactants, anionic surfactants, cationic surfactants, and amphoteric surfactants can be used, and a combination thereof may be used. In particular, among these surfactants, an acetylene glycol surfactant, a silicone surfactant, or a fluorine surfactant can be used.

The acetylene glycol surfactant is not particularly limited, and examples thereof include Surfynol series 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (trade names, manufactured by Air Products and Chemicals, Inc.), Olfine series B, Y, P, A, STG, SPC, E1004, E1010, PD-001, PD-002W, PD-003, PD-004, PD-005, EXP.4001, EXP.4036, EXP.4051, AF-103, AF-104, AK-02, SK-14, and AE-3 (trade names, manufactured by Nissin Chemical Co., Ltd.), and Acetylenol series E00, E00P, E40, and E100 (trade names, manufactured by Kawaken Fine Chemicals Co., Ltd.).

Although the silicone surfactant is not particularly limited, a polysiloxane compound may be used. The polysiloxane compound is not particularly limited, and, for example, polyether modified organosiloxane is mentioned. As the commercial products of the polyether modified organosiloxane, for example, BYK-306, BYK-307, BYK-333, BYK-341, BYK-345, BYK-346, and BYK-348 (trade names, manufactured by BYK) and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, manufactured by Shin-Etsu Chemical Co., Ltd.) are mentioned.

As the fluorine surfactant, a fluorine modified polymer may be used, and examples thereof include BYK-340 (trade name, manufactured by BYK Chemie Japan K.K.).

When surfactants are mixed with an aqueous ink jet composition, the total amount of the surfactants can be 0.01 mass % or more and 3 mass % or less based on the total mass of the aqueous ink jet composition and may be 0.05 mass % or more and 2 mass % or less, 0.1 mass % or more and 1.5 mass % or less, or 0.2 mass % or more and 1 mass % or less.

In addition, the aqueous ink jet composition containing a surfactant tends to increase the stability when an ink is discharged from a head.

### Resin Particle

The aqueous ink jet composition may contain a resin particle in addition to the above-described polyester. Examples of the resin particle include resin particles made of a urethane resin, an acrylic resin (including a styrene acrylic resin), a fluorene resin, a polyolefin resin, a rosin modified resin, a terpene resin, a polyamide resin, an epoxy resin, a vinyl chloride resin, a vinyl chloride-vinyl acetate copolymer, or an ethylene vinyl acetate resin. In particular, a urethane resin, an acrylic resin, or a polyolefin resin may be used. These resin particles are often handled in emulsion form, but may have properties of powder. The resin particles may be one type of particle or a combination of two or more types of particles.

The urethane resin is a generic name of resins having a urethane bond. As the urethane resin, for example, a polyether urethane resin having an ether bond in the main chain in addition to the urethane bond, a polyester urethane resin having an ester bond in the main chain in addition to the urethane bond, or a polycarbonate urethane resin having a carbonate bond in the main chain in addition to the urethane bond may be used. In addition, as the urethane resin, a commercial product may be used. For example, SUPERFLEX series 460, 460s, 840, and E-4000 (trade names, manufactured by DKS Co., Ltd.), RESAMINE series D-1060, D-2020, D-4080, D-4200, D-6300, and D-6455 (trade names, manufactured by Dainichiseika Color & Chemicals Mfg. Co., Ltd.), Takelac series WS-5100, WS-6021, and W-512-A-6 (trade names, manufactured by Mitsui Chemicals Polyurethanes, Inc.), Sancure 2710 (trade name, manufactured by The Lubrizol Corporation), and PERMARIN UA-150 (trade name, manufactured by Sanyo Chemical Industries, Ltd.) may be used.

The acrylic resin is a generic name of polymers obtained by polymerizing at least an acrylic monomer, such as (meth)acrylic acid or (meth)acrylic ester, as one component, and examples thereof include a resin obtained from an acrylic monomer and a copolymer of an acrylic monomer and another monomer. For example, an acrylic vinyl resin, which is a copolymer of an acrylic monomer and a vinyl monomer, is mentioned. In addition, for example, styrene is mentioned as the vinyl monomer.

As the acrylic monomer, for example, acryl amide and acrylonitrile can also be used. The resin emulsion using an acrylic resin as a raw material may be a commercial product and may be selected from, for example, FK-854 (trade name, manufactured by Chuo Rika Kogyo Corporation), Movinyl series 952B and 718A (trade names, manufactured by The Nippon Synthetic Chemical Industry Co., Ltd.), and Nipol series LX852 and LX874 (trade names, manufactured by Zeon Corporation).

Incidentally, in the present specification, the acrylic resin may be a styrene-acrylic resin described below. In addition, in the present specification, the notation “(meth)acrylic” means at least one of acrylic and methacrylic.

The styrene-acrylic resin is a copolymer prepared from a styrene monomer and a (meth)acrylic monomer, and examples thereof include a styrene-acrylic acid copolymer, a styrene-methacrylic acid copolymer, a styrene-methacrylic acid-acrylic ester copolymer, a styrene-α-methylstyrene-acrylic acid copolymer, and a styrene-α-methylstyrene-acrylic acid-acrylic ester copolymer. As the styrene-acrylic resin, a commercial product may be used. For example, Joncryl series 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (trade names, manufactured by BASF SE), Movinyl series 966A and 975N (trade names, manufactured by The Nippon Synthetic Chemical Industry Co., Ltd.), Vinylblan 2586 (trade name, manufactured by Nissin Chemical Co., Ltd.), and Bonron S-1120 (trade name, manufactured by Mitsui Chemicals, Inc.) may be used.

The polyolefin resin has olefin, such as ethylene, propylene, or butylene, in the structure skeleton, and an appropriately selected known polyolefin resin can be used. As the olefin resin, commercial products can be used, and for example, Arrowbase CB-1200 or CD-1200 (trade names, manufactured by UNITIKA Ltd.) may be used.

In addition, the resin particles may be supplied in emulsion form, and examples of commercial product of such resin emulsion include Microgel series E-1002 and E-5002 (trade names, manufactured by Nippon Paint Co., Ltd., styrene-acrylic resin emulsion), VONCOAT 4001 (trade name, manufactured by DIC Corporation, acrylic resin emulsion), VONCOAT 5454 (trade name, manufactured by DIC Corporation, styrene-acrylic resin emulsion), Polysol series AM-710, AM-920, AM-2300, AP-4735, AT-860, and PSASE-4210E (acrylic resin emulsion), Polysol AP-7020 (styrene-acrylic resin emulsion), Polysol SH-502 (vinyl acetate resin emulsion), Polysol series AD-13, AD-2, AD-10, AD-96, AD-17, and AD-70 (ethylene-vinyl acetate resin emulsion), Polysol PSASE-6010 (ethylene-vinyl acetate resin emulsion) (trade names, manufactured by Showa Denko K.K.), SAE1014 (trade name, styrene-acrylic resin emulsion, manufactured by Zeon Corporation), SAIVINOL SK-200 (trade name, acrylic resin emulsion, manufactured by Saiden Chemical Industry Co., Ltd.), AE-120A (trade name, manufactured by JSR Corporation, acrylic resin emulsion), AE373D (trade name, manufactured by Emulsion Technology Co., Ltd., carboxy modified styrene-acrylic resin emulsion), SEIKADYNE 1900W (trade name, manufactured by Dainichiseika Color & Chemicals Mfg. Co., Ltd., ethylene-vinyl acetate resin emulsion), VINYBLAN 2682 (acrylic resin emulsion), VINYBLAN 2886 (vinyl acetate-acrylic resin emulsion), VINYBLAN 5202 (acetic acid acrylic resin emulsion) (trade names, manufactured by Nissin Chemical Co., Ltd.), Takelac series W-6020, W-635, W-6061, W-605, W-635, and W-6021 (trade names, manufactured by Mitsui Chemicals Polyurethanes, Inc., urethane resin emulsion), SUPERFLEX series 870, 800, 150, 420, 460, 470, 610, and 700 (trade names, manufactured by DKS Co., Ltd., urethane resin emulsion), PERMARIN UA-150 (manufactured by Sanyo Chemical Industries, Ltd., urethane resin emulsion), Sancure 2710 (manufactured by The Lubrizol Corporation, urethane resin emulsion), NeoRez series R-9660, R-9637, and R-940 (manufactured by Kusumoto Chemicals, Ltd., urethane resin emulsion), ADEKA BONTIGHTER series HUX-380 and 290K (manufactured by ADEKA Corporation, urethane resin emulsion), Movinyl 966A and Movinyl 7320 (manufactured by The Nippon Synthetic Chemical Industry Co., Ltd.), Joncryl series 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (manufactured by BASF SE), NK Binder R-5HN (manufactured by Shin-Nakamura Chemical Co., Ltd.), HYDRAN WLS-210 (non-crosslinkable polyurethane: manufactured by DIC Corporation), and Joncryl 7610 (manufactured by BASF SE).

The content of the resin particles contained in the aqueous ink jet composition is 0.1 mass % or more and 20 mass % or less as the solid content based on the total mass of the aqueous ink jet composition and may be 1 mass % or more and 15 mass % or less or 2 mass % or more and 10 mass % or less.

### Chelating Agent

The aqueous ink jet composition of the present embodiment may use a chelating agent. The chelating agent can remove a certain ion in the aqueous ink jet composition.

Examples of the chelating agent include ethylenediaminetetraacetic acid and salts thereof, such as EDTA, EDTA-2Na (disodium dihydrogen ethylenediaminetetraacetate), EDTA-3Na (trisodium hydrogen ethylenediaminetetraacetate), EDTA-4Na (tetrasodium ethylenediaminetetraacetate), and EDTA-3K (tripotassium hydrogen ethylenediaminetetraacetate); diethylenetriaminepentaacetic acid and salts thereof, such as DTPA, DTPA-2Na (disodium diethylenetriaminepentaacetate) and DTPA-5Na (pentasodium diethylenetriaminepentaacetate); nitrilotriacetic acid and salts thereof, such as NTA, NTA-2Na (disodium nitrilotriacetate) and NTA-3Na (trisodium nitrilotriacetate); ethylenediamine-N,N′-disuccinic acid and salts thereof; 3-hydroxy-2,2′-iminodisuccinic acid and salts thereof; L-aspartic-N,N′-diacetic acid and salts thereof; and N-(2-hydroxyethyl)iminodiacetic acid and salts thereof.

In addition, examples of the chelating agent other than acetic acid analogues include ethylenediaminetetramethylenephosphonic acid and salts thereof, ethylenediaminetetrametaphosphoric acid and salts thereof, ethylenediaminepyrophosphoric acid and salts thereof, and ethylenediaminemetaphosphoric acid and salts thereof.

When the aqueous ink jet composition of the present embodiment contains a chelating agent, one or more selected from the above-mentioned chelating agents can be used.

### pH Adjuster

The aqueous ink jet composition of the present embodiment can contain a pH adjuster. The pH adjuster is not particularly limited, and examples thereof include an appropriate combination of an acid, a base, a weak acid, and a weak base. Examples of the acid and the base to be used in the combination include inorganic acids, such as sulfuric acid, hydrochloric acid, and nitric acid; inorganic bases, such as lithium hydroxide, sodium hydroxide, potassium hydroxide, potassium dihydrogen phosphate, disodium hydrogen phosphate, potassium carbonate, sodium carbonate, sodium hydrogen carbonate, and ammonia.

As organic acids, for example, adipic acid, citric acid, succinic acid, lactic acid, a Good's buffer, such as N,N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), carbamoylmethyliminobisacetic acid (ADA), piperazine-1,4-bis(2-ethanesulfonic acid) (PIPES), N-(2-acetamide)-2-aminoethanesulfonic acid (ACES), cholamine chloride, N-tris(hydroxymethyl)methyl-2-aminoethanesulfonic acid (TES), acetamide glycine, tricine, glycinamide, and bicine, phosphate buffer, citrate buffer, or Tris buffer may be used.

### Ureas

As a moisturizing agent of the aqueous ink jet composition or as a dyeing assistant for improving the dyeing property of a dye, ureas may be used. Examples of the ureas include urea, ethyleneurea, tetramethylurea, thiourea, and 1,3-dimethyl-2-imidazolidinone. When ureas are contained, the content thereof can be 1 mass % or more and 10 mass % or less based on the total mass of the aqueous ink jet composition. Preservative, fungicide, and corrosion inhibitor

The aqueous ink jet composition may use a preservative and a fungicide. Examples of the preservative and fungicide include sodium benzoate, sodium pentachlorophenol, sodium 2-pyridinethiol-1-oxide, sodium sorbate, sodium dehydroacetate, 1,2-dibenzisothiazolin-3-one (PROXEL CRL, PROXEL BDN, PROXEL GXL, PROXEL XL-2, PROXEL TN, and PROXEL LV of ZENECA Inc.), and 4-chloro-3-methylphenol (e.g., PREVENTOL CMK of Bayer AG). Examples of the corrosion inhibitor include benzotriazole.

### Saccharides

In order to suppress the solidification and drying of the aqueous ink jet composition, saccharides may be used. Examples of the saccharides include glucose, mannose, fructose, ribose, xylose, arabinose, galactose, aldonic acid, glucitol (sorbitol), maltose, cellobiose, lactose, sucrose, trehalose, and maltotriose.

### Others

Furthermore, as components other than the above-mentioned components, the aqueous ink jet composition may contain additives that can be usually used in aqueous ink jet compositions for ink jet, such as an antioxidant, an UV absorber, an oxygen absorber, and a dissolving assistant.

The content of the above-mentioned other components can be 20 mass % or less and may be 15 mass % or less. Incidentally, when multiple other components are contained, the total of contents thereof may satisfy the above-mentioned condition.

### 1.7. Relationship Between Contents

The aqueous ink jet composition of the present embodiment is prepared such that the contents of the pigment, polyester, and 1-(hydroxyalkyl)-2-pyrrolidone have the following relationship.

That is, the aqueous ink jet composition is prepared such that the pigment, the polyester, and the 1-(hydroxyalkyl)-2-pyrrolidone have a relationship of expression (1): C≤A≤B, where A is the content (mass %) of the pigment with respect to the total mass of the aqueous ink jet composition, B is the content (mass %) of the polyester with respect to the total mass, and C is the content (mass %) of the 1-(hydroxyalkyl)-2-pyrrolidone with respect to the total mass.

When the contents of the pigment, polyester, and 1-(hydroxyalkyl)-2-pyrrolidone have the relationship of expression (1), excellent clogging recovery and recorded matters having good fixability of images can be obtained.

In addition, the contents of the pigment, polyester, 1-(hydroxyalkyl)-2-pyrrolidone may have a relationship of the following expression (1-1): C<A<B. Consequently, the above-mentioned effects are more notably obtained.

The aqueous ink jet composition of the present embodiment may be prepared such that the contents of the 1-(hydroxyalkyl)-2-pyrrolidone and organic amine have the following relationship. That is, the aqueous ink jet composition may have a relationship of expression (2): D≤C, where C is the content (mass %) of the 1-(hydroxyalkyl)-2-pyrrolidone with respect to the total mass of the aqueous ink jet composition, and D is the content (mass %) of the organic amine with respect to the total mass.

When the aqueous ink jet composition contains 1-(hydroxyalkyl)-2-pyrrolidone and an organic amine so as to have a relationship of expression (2), further excellent clogging recovery is obtained, and printing with further good fixability can be performed.

In addition, the contents of the 1-(hydroxyalkyl)-2-pyrrolidone and the organic amine may have a relationship of expression (2-1): D<C. Consequently, the above-mentioned effects are more notably obtained.

### 1.8. Manufacturing and Physical Properties of Aqueous Ink Jet Composition

The aqueous ink jet composition can be obtained by mixing the above-mentioned components in an arbitrary order, performing, for example, filtration as needed, and removing impurities. As the method for the mixing, a method of sequentially adding materials to a container equipped with a stirring device, such as a mechanical stirrer or a magnetic stirrer, and stirring and mixing them may be employed. As the method for filtration, for example, centrifugal filtration or filter filtration can be performed as needed.

The lower limit of surface tension of the aqueous ink jet composition at 25° C. is not particularly limited and may be 20 mN/m, 21 mN/m, or 23 mN/m. In addition, the upper limit of surface tension of the aqueous ink jet composition at 25° C. is not particularly limited and may be 50 mN/m, 40 mN/m, or 30 mN/m.

Consequently, the nozzle of a discharging device of an ink jet system is less likely to be clogged, and the discharge stability of the aqueous ink jet composition is further improved. In addition, even if the nozzle is clogged, the nozzle can be capped, that is, the recoverability by capping can be made more excellent.

Incidentally, as the surface tension, the value measured by a Wilhelmy method can be used. In the measurement of surface tension, for example, a surface tensiometer, such as CBVP-7 manufactured by Kyowa Interface Science Co., Ltd., can be used.

The lower limit of viscosity at 25° C. of the aqueous ink jet composition is not particularly limited and may be 2 mPa·s, 3 mPa·s, or 4 mPa·s. In addition, the upper limit of viscosity at 25° C. of the aqueous ink jet composition is not particularly limited and may be 30 mPa·s, 20 mPa·s, or 10 mPa·s.

Consequently, the discharge stability of the aqueous ink jet composition is further improved.

Incidentally, the viscosity can be measured at 25° C., for example, using a viscoelastometer, such as MCR-300 manufactured by Pysica, by raising the shear rate from 10 [s⁻¹] to 1000 [s⁻¹] and reading the viscosity at the time when the shear rate is 200 [s⁻¹].

When the aqueous ink jet composition is an ink, the ink is usually applied to a recording apparatus for an ink jet method in a state stored in a container, such as a cartridge, a bag, or a tank. In other words, the recording apparatus according to the present disclosure includes a container, such as an ink cartridge, for storing an ink as an aqueous ink jet composition.

### 1.9. Effects

The aqueous ink jet composition of the present embodiment can be excellent in clogging recovery by containing 1-(hydroxyalkyl)-2-pyrrolidone. In addition, in the aqueous ink jet composition, since the contents of the pigment, polyester, and 1-(hydroxyalkyl)-2-pyrrolidone have a relationship of expression (1), printing with good fixability can be performed.

### 2. Method for Manufacturing Recorded Matter

The method for manufacturing a recorded matter of the present embodiment includes an imparting step of discharging the aqueous ink jet composition described above by an ink jet method to impart the composition to a recording medium and a heating step of heating the recording medium imparted with the aqueous ink jet composition to a temperature not lower than the glass transition temperature of the polyester.

Consequently, images having excellent fixability can be formed on various recording media. In addition, when the imparting step is performed by an ink jet system, very good clogging recovery can be expressed.

### Imparting Step

In the imparting step, the aqueous ink jet composition is discharged by an ink jet system to impart the composition to a recording medium. The discharge of the aqueous ink jet composition by the ink jet system can be performed using a known ink jet recording apparatus. As the discharge method, for example, a piezoelectric system or a system of heating an ink and discharging the ink by the generated bubbles can be used.

In the imparting step, a combination of a plurality of aqueous ink jet compositions may be used. More specifically, for example, a combination of a plurality of aqueous ink jet compositions in which the compositions of the pigments are different from each other may be used. In addition, in the imparting step, an ink other than the aqueous ink jet composition according to the present disclosure may be used in combination.

### Recording Medium

The material constituting the recording medium is not particularly limited, and examples thereof include resin materials, such as polyurethane, polyethylene, polypropylene, polyester, polyamide, and an acrylic resin; paper, glass, metal, ceramics, leather, wood, pottery, and fibers made of at least one thereof; and various natural, synthetic, and semi-synthetic fibers, such as silk, hair, cotton, hemp, polyester, polyamide (nylon), acryl, polyurethane, cellulose, linter, rayon, cupra, and acetate. One or a combination of two or more selected from these materials can be used. In addition, the recording medium may have a three-dimensional shape, such as a sheet-like, spherical, or rectangular parallelepiped shape.

The recording medium may be a fabric. There is a great demand for dyeing fabrics in, for example, printed T-shirts. While printing by, e.g., ironing is widespread, there is a strong demand for dyeing fabrics other than polyester fiber fabrics. Accordingly, when the recording medium is a fabric, the above-described effects are more significantly exhibited.

In addition, the recording medium may be made of a material including one or more selected from the group consisting of silk, wool, cellulose, acryl, polyurethane, and polyamide.

These materials have a strong demand for dyeing but are not suitable for dyeing using a sublimation dye or a disperse dye so far because of, for example, the heat-resistant temperature. In contrast, in the present disclosure, even if a recording medium made of such a material is used, a recorded matter can be suitably manufactured. Accordingly, when the recording medium is made of a material including one or more selected from the group consisting of silk, wool, cellulose, acryl, polyurethane, and polyamide, the effects of the aqueous ink jet composition are more significantly exhibited.

Among the fibers used for fabrics, hemp and hair (e.g., wool) are easily fluffed. Easily fluffing hemp and hair come contact with an ink jet head and easily cause nozzle omission, and even if nozzle omission can be avoided, since the fabric has a large number of micro holes and irregularities, the ink is unlikely to land, and the fabric is not suitable for ink jet printing. Cotton, silk, polyester, polyamide, acryl, and polyurethane that are unlikely to fluff are suitable for ink jet printing.

Accordingly, the recording medium may be made of a material containing one or more selected from the group consisting of cotton, silk, polyester, polyamide, acryl, and polyurethane.

### Heating Step

Subsequently, the recording medium imparted with the aqueous ink jet composition is heated to a temperature not lower than the glass transition temperature of the polyester. Consequently, the polyester softens and melts to form a film, and the pigment is fixed to the recording medium together with polyester.

The heating temperature in this step is not particularly limited as long as it is a temperature not lower than the glass transition temperature of the polyester, and may be 100° C. or more, 105° C. or more, or 110° C. or more. In addition, the heating temperature in this step may be 180° C. or less, 160° C. or less, or 150° C. or less. Although it also depends on the glass transition temperature of polyester, when the heating temperature in this step is 180° C. or less, the heat applied to a recording medium as the printing target can be suppressed, and, for example, a recording medium with relatively low heat resistance can also be suitably used. The range of selection of the recording medium is therefore further broadened. In addition, unwilling discoloration, a change in optical density, and so on by heating the manufactured recorded matter, for example, by heat treatment, such as washing/cleaning with hot water, heat drying with a dryer, or ironing, can be suitably prevented.

In addition, when a recording medium with relatively high heat resistance, for example, paper, glass, ceramics, metal, or wood, is used, the upper limit of the heating temperature in this step can be 250° C. and may be 220° C. or 200° C.

Although the heating time in this step varies depending on the heating temperature, the lower limit of the heating time in this step can be 0.2 seconds and may be 1 second or 5 seconds. In addition, the upper limit of the heating time in this step can be 300 seconds and may be 60 seconds or 30 seconds.

Consequently, the energy required to manufacture a recorded matter can be reduced, and the productivity of the recorded matter can be further improved. In addition, the color development property of the resulting recorded matter can be further improved. In addition, a recording medium with relatively low heat resistance can also be suitably applied, the range of selection of the recording medium is further broadened.

In addition, although this step can be performed by heating the surface of the recording medium imparted with the aqueous ink jet composition in a state of being separated from the heating member or can be performed by heating in a state in which the recording medium imparted with the aqueous ink jet composition and the heating member are in contact with each other, heating may be performed by heating in a state in which the recording medium imparted with the aqueous ink jet composition and the heating member are in contact with each other.

Consequently, the energy required to manufacture a recorded matter can be reduced, and the productivity of the recorded matter can be further improved. In addition, the color development property of the resulting recorded matter can be further improved. In addition, the pigment can be more effectively prevented from diffusing to the outside of the recording medium.

The method for manufacturing a recorded matter may further include other steps, in addition to the above-described steps, such as a preprocessing step, an intermediate processing step, a postprocessing step, and a transferring step. As the preprocessing step, for example, a step of applying a coat layer to the recording medium is mentioned. As the intermediate processing step, for example, a step of preheating the recording medium is mentioned. As the postprocessing step, for example, a step of washing the recording medium is mentioned. As the transferring step, a step of sublimation transferring the pigment to the recording medium to be dyed after the imparting step of imparting the aqueous ink jet composition to an intermediate transfer medium is mentioned.

According to the method for manufacturing a recorded matter, a recorded matter can be manufactured with good clogging recovery, and also the fixability of the image in the recorded matter can be made good.

### 3. Examples and Comparative Examples

The present disclosure will now be further specifically described by Examples, but is not limited to these Examples. Hereinafter, “%” is based on mass unless otherwise specified.

### 3.1. Preparation of Aqueous Ink Jet Composition

Components making each composition shown in Table 1 were stirred with a high-shear mixer (manufactured by Silverson) at 3000 rpm to produce each slurry. Subsequently, the produced slurry and glass beads having a diameter of 0.5 mm were subjected to stirring dispersion with a bead mill (LMZ015, Ashizawa Finetech Ltd.) under water cooling to manufacture an ink jet ink as an aqueous ink jet composition of each example.

TABLE 1

| | | Example | | | | | | Comparative Example | | | | | |
|---|---|---|---|---|---|---|---|---|---|---|---|---|---|
| | | 1 | 2 | 3 | 4 | 5 | 6 | 1 | 2 | 3 | 4 | 5 | 6 |
| Ink | Cyan pigment | 5.0 | — | — | — | 5.0 | 5.0 | — | — | — | — | — | 5.0 |
| composition | Magenta pigment | — | 5.0 | — | — | — | — | 4.0 | 5.0 | 5.0 | — | 5.0 | — |
| | Carbon black pigment | — | — | 5.0 | 5.0 | — | — | — | — | — | 6.0 | — | — |
| | Polyester (KT-9204, manufactured | 20.0 | 10.0 | 6.0 | 5.0 | 10.0 | 10.0 | 10.0 | 10.0 | 4.0 | 5.0 | — | 5.0 |
| | by UNITIKA Ltd. | | | | | | | | | | | | |
| | 1-(2-Hydroxyethyl)-2-pyrrolidone | — | 2.0 | 4.0 | 5.0 | 1.0 | 1.0 | — | — | 2.0 | 1.0 | 2.0 | 7.0 |
| | 1-(2-Hydroxypropyl)-2-pyrrolidone | 2.0 | — | — | — | — | — | — | — | — | — | — | — |
| | Triethanolamine | 0.5 | 0.2 | 2.0 | 2.0 | 0.5 | 0.5 | 0.5 | 0.2 | 0.2 | 2.0 | 1.0 | 1.0 |
| | Water | 63.5 | 73.8 | 74.0 | 74.0 | 74.5 | 73.5 | 71.5 | 73.8 | 79.8 | 77.0 | 73.0 | 73.0 |
| | Styrene acrylic resin (manufactured | — | — | — | — | — | — | — | — | — | — | 10.0 | — |
| | by Mitsui Chemicals, Inc.) | | | | | | | | | | | | |
| | Glycerol | 6.0 | 6.0 | 6.0 | 6.0 | 6.0 | 6.0 | 6.0 | 6.0 | 6.0 | 6.0 | 6.0 | 6.0 |
| | Triethylene glycol monobutyl ether | 2.0 | 2.0 | 2.0 | 2.0 | 2.0 | 2.0 | 2.0 | 2.0 | 2.0 | 2.0 | 2.0 | 2.0 |
| | 2-Pyrrolidone | — | — | — | — | — | 1.0 | 5.0 | 2.0 | — | — | — | — |
| | E1010 | 1.0 | 1.0 | 1.0 | 1.0 | 1.0 | 1.0 | 1.0 | 1.0 | 1.0 | 1.0 | 1.0 | 1.0 |
| Evaluation | Number of nozzles with nozzle | 0 | 0 | 0 | 0 | 0 | 0 | 13 | 10 | 8 | 25 | 53 | 12 |
| result | omission (total number of | | | | | | | | | | | | |
| | nozzles: 800) | | | | | | | | | | | | |
| | Fixability (tape peeling test) | A | A | A | A | A | A | B | B | B | B | B | B |

In Table 1, the polyester used was ELITEL (registered trademark) KT9204 (glass transition temperature: 18° C.) manufactured by UNITIKA Ltd. The styrene-acrylic resin used was Bonron S-1120 (glass transition temperature: 4° C.) manufactured by Mitsui Chemicals, Inc. Olfine E1010 is an acetylene glycol surfactant manufactured by Nissin Chemical Co., Ltd.

### 3.2. Method of Evaluation

### 3.2.1. Evaluation of Clogging Recovery

As evaluation of clogging recovery, the number of nozzles with nozzle omission was checked. The aqueous ink jet composition of each example was introduced to the cartridge of PX-M860F ink jet printer manufactured by SEIKO EPSON CORPORATION, and printing was performed. As conditions for causing nozzle omission, the power was turned off during printing, the printer was left to stand at 40° C. for 1 day in a state in which the head was out of the cap, the cleaning was then operated 5 times, a check pattern was printed, and the number of nozzles with nozzle omission was counted. The total number of the nozzles was 800. The number of nozzles with nozzle omission in each example is shown in Table 1.

### 3.2.2. Evaluation of Fixability

A predetermined pattern was recorded at room temperature 25° C. using each of the aqueous ink jet compositions of Examples and Comparative Examples on a PET film with a recording apparatus PX-M860F (manufactured by SEIKO EPSON CORPORATION). The resulting recorded matters were dried at 70° C. for 12 hours, and Scotch tape manufactured by 3M was then attached to the pattern portions. Then, the tape was peeled to perform a tape peeling test for evaluating the fixability. The evaluation was based on the following criteria, and the results are shown in Table 1.

A: without peeling, and

B: with peeling.

### 3.3. Evaluation Results

In all the aqueous ink jet compositions of Examples each including a pigment (A), polyester (B), 1-(hydroxyalkyl)-2-pyrrolidone (C), an organic amine (D), and water and having a relationship of expression (1) (C≤A≤B), the results showed that the clogging recovery and the fixability of images were excellent.

The above-described embodiments and modifications are merely examples, and the present disclosure is not limited thereto. For example, it is possible to appropriately combine each embodiment and each modification.

The present disclosure includes configurations that are substantially the same as those described in the embodiments, for example, a configuration having the same function, method, and result or a configuration having the same purpose and effect. In addition, the present disclosure includes configurations in which non-essential parts of the configurations described in the embodiments are replaced. In addition, the present disclosure includes configurations that have the same effects or achieve the same purposes as those of the configurations described in the embodiments. Furthermore, the present disclosure includes configurations in which known techniques are added to the configurations described in the embodiments.

The following contents are derived from the above-described embodiments and modifications.

An aspect of the aqueous ink jet composition includes: a pigment, polyester, 1-(hydroxyalkyl)-2-pyrrolidone, an organic amine, and water, wherein the pigment, the polyester, and the 1-(hydroxyalkyl)-2-pyrrolidone have a relationship of expression (1): C≤A≤B, where A is the content (mass %) of the pigment with respect to the total mass of the aqueous ink jet composition, B is the content (mass %) of the polyester with respect to the total mass of the aqueous ink jet composition, and C is the content (mass %) of the 1-(hydroxyalkyl)-2-pyrrolidone with respect to the total mass of the aqueous ink jet composition.

According to this aqueous ink jet composition, since 1-(hydroxyalkyl)-2-pyrrolidone is contained, the clogging recovery is excellent. In addition, according to this aqueous ink jet composition, since the contents of the pigment, polyester, and 1-(hydroxyalkyl)-2-pyrrolidone have a relationship of expression (1), printing with good fixability can be performed.

In the aqueous ink jet composition of the aspect above, the content of the polyester may be 10.0 mass % or more and 30.0 mass % or less based on the total mass of the composition.

According to this aqueous ink jet composition, printing with further good fixability can be performed.

In the aqueous ink jet composition of the aspect above, the content of the 1-(hydroxyalkyl)-2-pyrrolidone may be 1.0 mass % or more and 5.0 mass % or less based on the total mass of the composition.

According to this aqueous ink jet composition, printing with further excellent clogging recovery can be performed.

In the aqueous ink jet composition of the aspect above, the polyester may include polyester particles having an volume average particle diameter of 20.0 nm or more and 300.0 nm or less.

According to this aqueous ink jet composition, the dispersion stability of the polyester, the storage stability of the aqueous ink jet composition, the discharge stability of the aqueous ink jet composition by an ink jet method, and the clogging recovery can be made more excellent.

In the aqueous ink jet composition of the aspect above, there is a relationship of expression (2): D≤C, where D (mass %) is the content of the organic amine based on the total mass of the aqueous ink jet composition.

According to this aqueous ink jet composition, printing with further good fixability can be performed.

An aspect of the method for manufacturing a recorded matter includes: an imparting step of discharging the aqueous ink jet composition described above by an ink jet method to impart the composition to a recording medium, and a heating step of heating the recording medium imparted with the aqueous ink jet composition to a temperature not lower than the glass transition temperature of the polyester.

According to this method for manufacturing a recorded matter, a recorded matter can be manufactured with good clogging recovery, and also the fixability of the image in the recorded matter can be made good.

What is claimed is:

1. An aqueous ink jet composition comprising:
a pigment;
polyester;
1-(hydroxyalkyl)-2-pyrrolidone;
an organic amine; and
water, wherein
the pigment, the polyester, and the 1-(hydroxyalkyl)-2-pyrrolidone have a relationship of expression (1): C≤A≤B, where A is the content (mass %) of the pigment with respect to the total mass of the aqueous ink jet composition, B is the content (mass %) of the polyester with respect to the total mass of the aqueous ink jet composition, and C is the content (mass %) of the 1-(hydroxyalkyl)-2-pyrrolidone with respect to the total mass of the aqueous ink jet composition.

2. The aqueous ink jet composition according to claim 1, wherein
the content of the polyester is 10.0 mass % or more and 30.0 mass % or less based on the total mass of the composition.

3. The aqueous ink jet composition according to claim 1, wherein
the content of the 1-(hydroxyalkyl)-2-pyrrolidone is 1.0 mass % or more and 5.0 mass % or less based on the total mass of the composition.

4. The aqueous ink jet composition according to claim 1, wherein
the polyester includes polyester particles having a volume average particle diameter of 20.0 nm or more and 300.0 nm or less.

5. The aqueous ink jet composition according to claim 1, wherein
there is a relationship of expression (2): D≤C, where D (mass %) is a content of the organic amine based on the total mass of the aqueous ink jet composition.

6. A method for manufacturing a recorded matter, comprising:
an imparting step of discharging the aqueous ink jet composition according to claim 1 by an ink jet method to impart the composition to a recording medium, and
a heating step of heating the recording medium imparted with the aqueous ink jet composition to a temperature not lower than the glass transition temperature of the polyester.
